(19) United States
(12) Patent Application Publication
(10) Pub. No.: US 2018/0146231 A1
(43) Pub. Date: May 24, 2018

(54) WIRELESS AUDIO/VIDEO STREAMING NETWORK

(71) Applicant: THOMSON Licensing, Issy Les Moulineaux (FR)

(72) Inventor: Saman SAEEDASR, Indianapolis, IN (US)

(21) Appl. No.: 15/574,436

(22) PCT Filed: Jun. 6, 2016
(86) PCT No.: PCT/US16/35973

§ 371 Date: Nov. 15, 2017

Related U.S. Application Data
(60) Provisional application No. 62/180,396, filed on Jun. 16, 2015.

(51) Int. Cl. H04N 21/41; H04N 21/414; H04N 21/436; H04N 21/4363

(52) U.S. Cl. CPC H04N 21/4122; H04N 21/41407; H04W 84/12; H04N 21/43637; H04N 21/43615

(57) ABSTRACT

A method and apparatus for operating a mobile device are described including receiving content on a mobile device, determining if the mobile device is proximate to an electronic device, the electronic device capable of providing better rendering quality and forwarding the received content to an access point or multimedia over cable client device responsive to the determination. Also described area a method and apparatus for operating an access point including receiving content, by the access point, from a mobile device, first determining quality of the received content, second determining if the access point has sufficient processing power to transcode the received content, transcoding the received content by the access point responsive to the determination, forwarding the transcoded content to a WiFi client.

### FIELD

The proposed method and apparatus relates to streaming audio, video and multimedia received on users' mobile devices to a TV through a gateway device or client device in a room where the user is located.

### BACKGROUND

This section is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

By using the proposed method and apparatus, the user will not need an extra speaker to play audio in the room when they already have a TV therein. By using the proposed method and apparatus the user does not need an extra system other than the available client device and the TV in the room and the user can use the TV's built in speakers.

### SUMMARY

The proposed method and apparatus will help the user to stream audio/video that users have on the their electronic devices to their TVs through the set-top box or client devices available in the room. As used herein the term “server” includes any gateway device including set top boxes (STBs).

A method and apparatus for operating a mobile device are described including receiving content on a mobile device, determining if the mobile device is proximate to an electronic device, the electronic device capable of providing better rendering quality and forwarding the received content to an access point or multimedia over cable client device responsive to the determination. Also described are a method and apparatus for operating an access point including receiving content, by the access point, from a mobile device, first determining quality of the received content, second determining if the access point has sufficient processing power to transcode the received content, transcoding the received content by the access point responsive to the determination, forwarding the transcoded content to a WiFi client. Also described are a method and apparatus for operating an access point including receiving content, by the access point, from a mobile device, first determining quality of the received content, second determining if the access point has sufficient processing power to transcode the received content, forwarding the received content to a gateway device responsive to the second determination, receiving transcoded content from the gateway device and forwarding the transcoded content to a WiFi client. Also described are a method and apparatus for operating a multimedia over cable client device including receiving content, by the multimedia over cable client device, from a mobile device, forwarding the received content to a gateway device, receiving transcoded content from the gateway device, and forwarding the transcoded content to an electronic device for rendering. Also described are a method and apparatus for operating a gateway device, including receiving content from an access point or a multimedia over cable client device, transcoding the received content and returning the transcoded content to the access point or the over cable client device.

### BRIEF DESCRIPTION OF THE DRAWINGS

The proposed method and apparatus is best understood from the following detailed description when read in conjunction with the accompanying drawings. The drawings include the following figures briefly described below:

FIG. 1 is a schematic diagram of exemplary embodiments of the proposed apparatus in accordance with the principles of the proposed method and apparatus.

FIG. 2 is a flowchart of the operation of an exemplary mobile device in accordance with the principles of the proposed method and apparatus.

FIG. 3 is a flowchart of the operation of an exemplary access point in accordance with the principles of the proposed method and apparatus.

FIG. 4 is a flowchart of the operation of an exemplary MoCA client device in accordance with the principles of the proposed method and apparatus.

FIG. 5 is a flowchart of the operation of an exemplary gateway device in accordance with the principles of the proposed method and apparatus.

FIG. 6 is a block diagram of an exemplary mobile device in accordance with the principles of the proposed method and apparatus.

FIG. 7 is a block diagram of an exemplary access point device in accordance with the principles of the proposed method and apparatus.

FIG. 8 is a block diagram of an exemplary MoCA client device in accordance with the principles of the proposed method and apparatus.

FIG. 9 is a block diagram of an exemplary gateway device in accordance with the principles of the proposed method and apparatus.

It should be understood that the drawing(s) are for purposes of illustrating the concepts of the disclosure and is not necessarily the only possible configuration for illustrating the disclosure.

### DETAILED DESCRIPTION OF THE PREFERRED EMBODIMENTS

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Since connected home systems are already using Multimedia over Cable (MoCA) technology there are two alternative embodiments of the proposed method and apparatus.

In the first embodiment, as long as Wi-Fi is available, by using it and adding another Wi-Fi bridge to the access point in the system the user can provide the content (data, information) from their mobile device (e.g., phone) and have the content rendered on their TV. By using the proposed method and apparatus, there is no need for any hardware changes in the (wireless) client or the server (gateway device, set top box). Adding an application to the user's mobile device (phone, tablet, laptop, etc.) can make the device a source and send (transmit, forward, communicate) the content (data, information) to the server (e.g., H44, gateway device, set top box . . . ) and choose on which client device the user wants to receive the data (content, audio, video, information.). The client can then send (transmit, forward, communicate) the data (information, content) to the TV, so the user can enjoy the content (audio, video, data, information) in the room in which the user is located.

In a second embodiment, a Bluetooth system is added to a MoCA client device if a Bluetooth system is not already built-in the MoCA client device. The user's electronic (mobile) device will be the source and the client is connected to the set-top box through the MoCA. It is thereby possible to render (play, view) the content (audio, video, data, information) from the same client which received the data from user's mobile device.

The proposed method and apparatus uses hardware that is already built into the server (STB) and the available network (single network) so as not to add cost to the equipment. Even if it is necessary to add Bluetooth, that cost is minimal to add to the client devices. The proposed method and apparatus does not use a DVR or a PVR. Transcoding is usually performed by the STB (server) and decoding is usually performed by the client or the TV in the case of built-in Wi-Fi in the TV. The proposed method and apparatus differs, for example, from DLNA because DLNA is software and the proposed method and apparatus is a hardware solution.

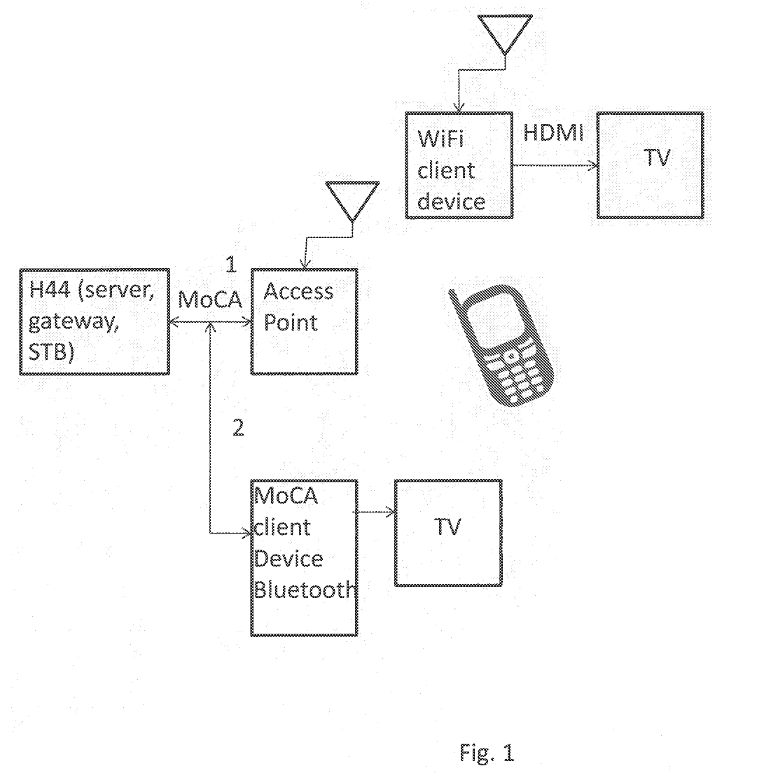

Referring to FIG. 1, the cell phone is meant to represent any mobile device including smart phones, tablets, laptops etc. In the first embodiment, the user who has received (downloaded, streamed) content (data, information, audio, video, multimedia) on their mobile device is now located in a room having a TV, which has a larger screen and speakers making the viewing (listening) a far better user experience. In order for the user to have the content (data, information, audio, video, multimedia) rendered on a TV, the user's mobile device has an application installed thereon. The application on the user's mobile device transmits (forwards, communicates, download, streams) the content (data, information, audio, video, multimedia) to the access point by a WiFi interface. The user's mobile device is also equipped with a WiFi interface. The access point transmits (forwards, communicates) the received content (data, information, audio, video, multimedia) to the gateway device (server, set top box). The content (data, information, audio, video, multimedia) needs to be transcoded for rendering on a TV. Transcoding is a procedure of modifying the received data (content, information, audio, video, multimedia) to TV format. Transcoding may be performed by either the gateway device (server, STB, H44) or by the access point. Where the transcoding is performed depends upon the processing power of the access point and the gateway device (server, STB, H44) and the quality (720 pixels, 1080 pixels) of the content (data, information, audio, video, multimedia). If there is enough processing power in the access point then the transcoding can be performed in the access point and the content need not be forwarded (transmitted, communicated) to the gateway device (server, STB, H44) for transcoding. If the access point does not have sufficient processing power to transcode the content (data, information, audio, video, multimedia) then the transcoding will need to be performed by the gateway device (server, STB, H44). Once the content (data, information, audio, video, multimedia) has been transcoded then the transcoded content is forwarded (transmitted, communicated) by the access point (from the server, STB, H44, gateway device if the transcoding was performed by the gateway device) to the WiFi client device through the WiFi interface. The WiFi client device forwards (transmits, communicates) the transcoded and decoded content to the selected TV by a HDMI interface. If the TV happens to be an ATSC 3.0 TV then the TV would have a built-in WiFi interface so the WiFi client device (bridge) would not be necessary and the TV would do the decoding in this case.

In the second embodiment, the user who has received (downloaded, streamed) content (data, information, audio, video, multimedia) on their mobile device is now located in a room having a TV, which has a larger screen and speakers making the viewing (listening) a far better user experience. In order for the user to have the content (data, information, audio, video, multimedia) rendered on a TV, the user's mobile device has an application installed thereon. The application on the user's mobile device transmits (forwards, communicates, download, streams) the content (data, information, audio, video, multimedia) to a MoCA client device by a Bluetooth interface. The user's mobile device is also equipped with a Bluetooth interface. The MoCA client device transmits (forwards, communicates) the received content (data, information, audio, video, multimedia) to the gateway device (server, set top box). The content (data, information, audio, video, multimedia) needs to be transcoded for rendering on a TV. Transcoding is a procedure of modifying the received data (content, information, audio, video, multimedia) to TV format. Transcoding involves the following processes: First the encoded content needs to be decoded with the corresponding decoder. The result is an uncompressed data stream. Second, the uncompressed data stream will be re-encoded with the encoder for which the TV set is equipped with the corresponding decoder. The result is a compressed stream which can be decoded in the TV set. Once the content (data, information, audio, video, multimedia) has been transcoded then the transcoded content is forwarded (transmitted, communicated) by the server (STB, H44, gateway device) to the MoCA client device. The MoCA client device forwards (transmits, communicates) the transcoded and decoded content to the selected TV through an HDMI interface.

The mobile device receives content (data, information, audio, video, multimedia) from a source outside of the system of the proposed method and apparatus. The mobile device then forwards (transmits, communicates) the received content (data, information, audio, video, multimedia) to either a MoCA client by a Bluetooth interface or to the access point through a WiFi interface. Before the mobile device transmits (forwards, communicates) the content (data, information, audio, video, multimedia) to either the MoCA client or the access point, the mobile device determines if it is in the vicinity of a TV which can be used to render the content (data, information, audio, video, multimedia).

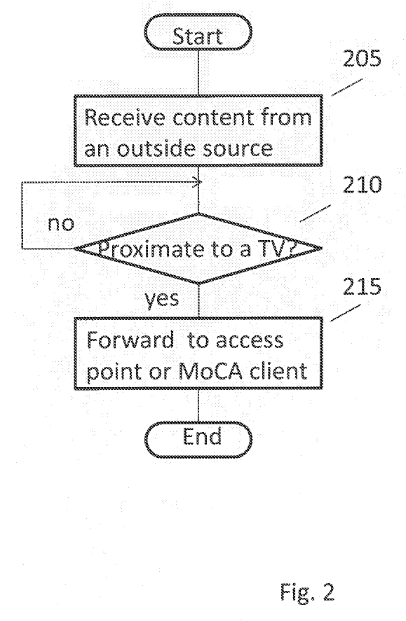

FIG. 2 is a flowchart of the operation of an exemplary mobile device in accordance with the principles of the proposed method and apparatus. At 205 the mobile device receives content (data, information, audio, video, multimedia) from a source outside of the system of the proposed method and apparatus. At 210 the mobile device determines if the mobile device is in the proximity of a TV for rendering the received content. TV is used here as an example of an electronic device which may be proximate to the mobile device. Other examples of electronic devices include laptop computer, computers, tablets and the like. The mobile device determines proximity to such a device for rendering the received content with better quality. The better quality may be audio quality or video quality or both audio and video quality. If the mobile device is in the proximity of a TV for rendering the received content then at 215 the mobile device forwards (transmits, communicates) the received content to either the MoCA client device (by Bluetooth) or the access point (by the WiFi interface). If the mobile device is not in the proximity of a TV for rendering the received content then processing proceeds to 210.

The access point receives content (audio, video, multimedia) from the user's mobile device and if the access point has sufficient processing power then the access point performs transcoding on the received content (audio, video, multimedia). The determination of sufficient processing power is dependent (at least in part) on the quality of the content. The access point then forwards the transcoded content to the WiFi client by a WiFi interface. The WiFi client device forwards (transmits, communicates) the transcoded and decoded content to the TV by an HDMI interface. If the access point does not have sufficient power to transcode the received content (audio, video, multimedia) then the access point forwards (transmits, communicates) the received content (audio, video, multimedia) to the gateway device (server, STB, H44) for transcoding. The access point communicates with the gateway device (server, STB, H44) by Ethernet or coaxial cable. Once the gateway device (server, STB, H44) completes the transcoding the gateway device (server, STB, H44) transmits (forwards, communicates) the transcoded content back to the access point. The access point then forwards the transcoded content to the WiFi client by a WiFi interface. The WiFi client device forwards (transmits, communicates) the transcoded and decoded content to the TV by an HDMI interface.

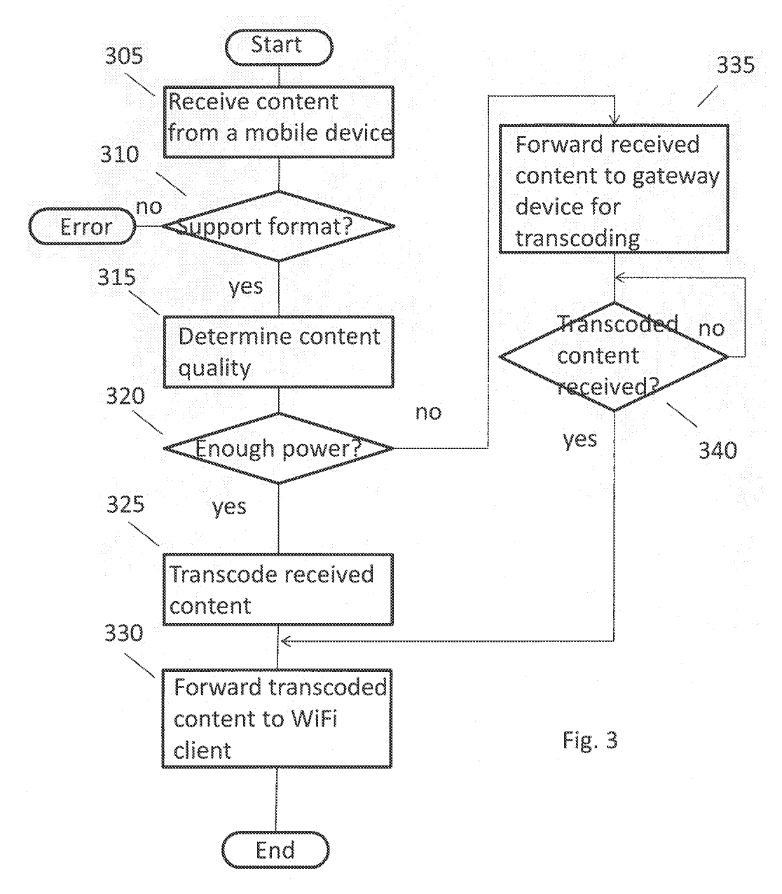

FIG. 3 is a flowchart of the operation of an exemplary access point in accordance with the principles of the proposed method and apparatus. At 305 the access point receives content (audio, video, multimedia) from a mobile device. At 310 the access point performs a test to determine the format of the received content to see if the format is supported or not. If the format is not supported then the user will get an error. If the format of the received content is supported then at 315 the access point determines the quality of the received content (audio, video, multimedia). At 320 a test is performed to determine if the access point possesses sufficient power to transcode the received content (audio, video, multimedia). If the access point possesses sufficient power to transcode the received content (audio, video, multimedia) then at 325 the access point transcodes the received content (audio, video, multimedia) and at 330 forwards the transcoded content to the WiFi client device. If the access point does not possess sufficient power to transcode the received content (audio, video, multimedia) then at 335 the access point forwards the received content (audio, video, multimedia) to the gateway device (server, H44, STB) for transcoding. The access point communicates with the gateway device (server, STB, H44) by Ethernet or coaxial cable. At 340 the access point determines if the transcoded content has been returned by the gateway device (server, H44, STB). The access point effectively remains in a tight loop until the access point receives the transcoded content back from the gateway device (server, STB, H44). Once the access point receives the transcoded content back from the gateway device (server, H44, STB) then processing proceeds to 330.

The WiFi client device receives transcoded content for rendering on a TV associated with the WiFi client and forwards the transcoded and decoded content to the associated TV by an HDMI interface. If the TV is an ATSC 3.0 TV then the TV will have a built-in WiFi interface and a separate WiFi client may not be necessary.

The MoCA client device receives content (audio, video, multimedia) from the user's mobile device The MoCA client device forwards the received content (audio, video, multimedia) to the gateway device (server, H44, STB) for transcoding. Once the gateway device (server, STB, H44) completes the transcoding the gateway device (server, STB, H44) transmits (forwards, communicates) the transcoded content back to the MoCA client device. The MoCA client device forwards (transmits, communicates) the transcoded and decoded content to the TV by an HDMI interface.

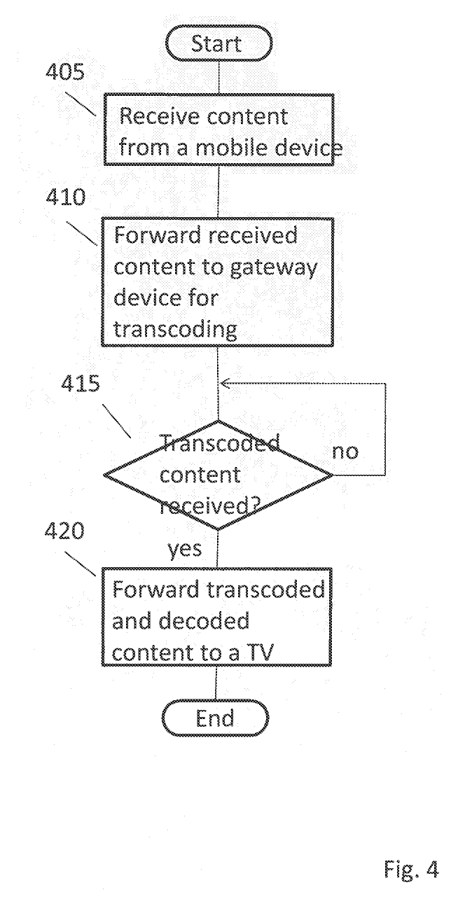

FIG. 4 is a flowchart of the operation of an exemplary MoCA client device in accordance with the principles of the proposed method and apparatus. At 405 the MoCA client device receives content (audio, video, multimedia) from a mobile device. At 410 the MoCA client device forwards the received content (audio, video, multimedia) to the gateway device (server, H44, STB) for transcoding. At 415 the MoCA client device determines if the transcoded content has been returned by the gateway device (server, H44, STB). The MoCA client device effectively remains in a tight loop until the MoCA client device receives the transcoded content back from the gateway device (server, STB, H44). Once the MoCA client device receives the transcoded content back from the gateway device (server, H44, STB) then at 420 the MoCA client device forwards the transcoded and decoded content to a TV associated with the MoCA client device by an HDMI interface.

It should be noted that at the present time neither the WiFi client nor the MoCA client have sufficient processing power to perform transcoding. However, as the cost of processing power decreases, it is likely that either or both the MoCA client and/or the WiFi client may have sufficient processing power to perform transcoding.

The gateway device (server, STB, H44) receives content (audio, video, multimedia) for transcoding from either the MoCA client device or the access point. The access point communicates with the gateway device (server, STB, H44) by Ethernet or coaxial cable. The gateway device (server, H44, STB) transcodes the received content and forwards (transits, communicates) the transcoded content back to the device which transmitted the received content (audio, video, multimedia) to the gateway device.

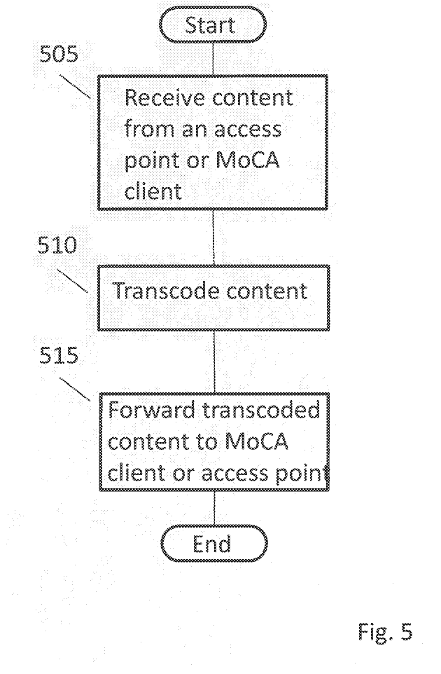

FIG. 5 is a flowchart of the operation of an exemplary gateway device (server, H44, STB) in accordance with the principles of the proposed method and apparatus. At 505 the gateway device (server, H44, STB) receives content (audio, video, multimedia) from either an access point or a MoCA client device. The access point communicates with the gateway device (server, STB, H44) by Ethernet or coaxial cable. At 510 the gateway device (server, H44, STB) transcodes the received content (audio, video, multimedia). At 515 the gateway device (server, H44, STB) forwards (transmits, communicates) the transcoded content back to the device which transmitted (forwarded, communicated) the content (audio, video, multimedia) to the gateway device (server, H44, STB).

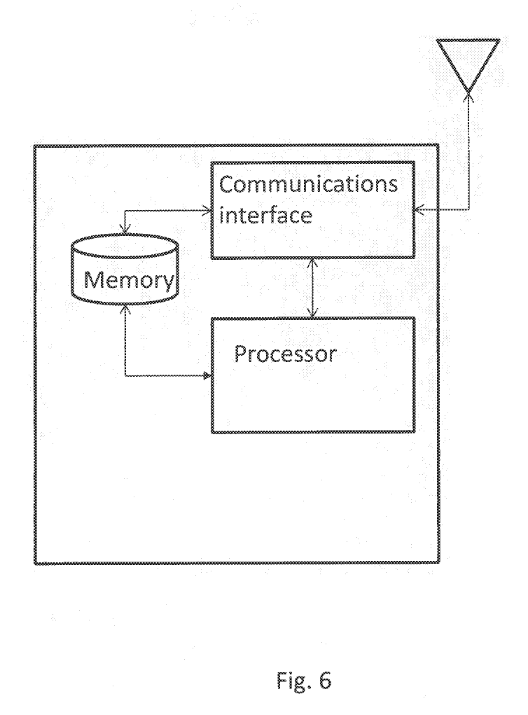

FIG. 6 is a block diagram of an exemplary mobile device in accordance with the principles of the proposed method and apparatus. The mobile device receives content (data, information, multimedia content) from a source such as a content provider by the communications interface. The received content is forwarded to a storage unit (memory), in the mobile device. The processor determines if mobile device is proximate to an electronic device capable of providing better quality rendering of the received content. Electronic devices include laptop computers, computers, tablets and the like. The mobile device determines proximity to such a device for rendering the received content with better quality. The better quality may be audio quality or video quality or both audio and video quality. The mobile device may use signal strength and other information received by the communications interface and forwarded to the processor of the mobile device to determine proximity to an electronic device. The additional information received by the communications interface is forwarded to the processor to determine proximity to an electronic device capable of better rendering quality. If the processor determines that the mobile device is proximate to such a device then the processor instructs the communications interface to forward the received content to an access point or MoCA client device depending on whether the proximate electronic is associated with the access point or the MoCA client device.

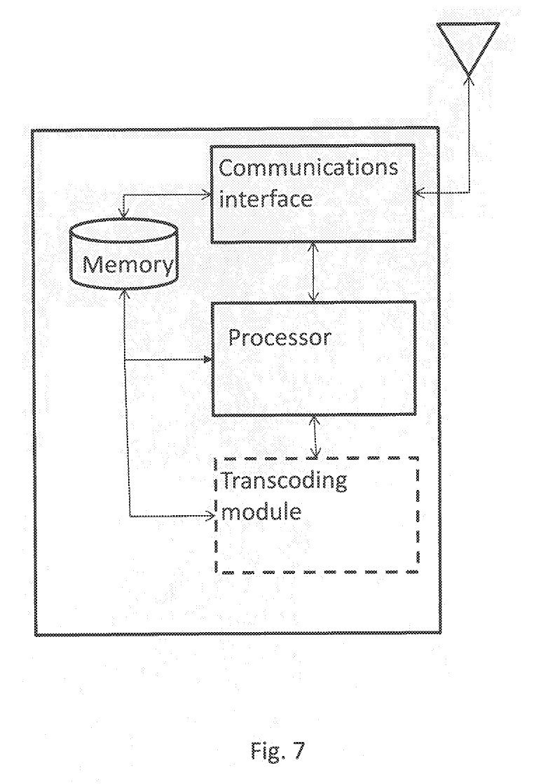

FIG. 7 is a block diagram of an exemplary access point device in accordance with the principles of the proposed method and apparatus. The access point includes a communications interface, which handles all communications including receiving content from a mobile device. The processor of the access point determines the quality of the received content. The processor of the access point also determines if it has sufficient processing power to transcode the received content. This determination may be at least in part based the quality of the received content. If the access point has sufficient processing power to transcode the received content then the transcoding module of the access point performs transcoding on the received content. The transcoding module is outlined in dashes to indicate that the transcoding module may be part of the processor or a separate module in the access point. The received content is stored in memory. Upon completion of the transcoding of the received content, the processor directs the communications interface to forward the transcoded content to a WiFi client associated with the proximate electronic device capable of better rendering quality. If the processor of the access point determines that the access point does not have sufficient processing power to transcode the received content then the processor of the access point directs the communications interface to forward the received content to a gateway device for transcoding. In this case (event) the communications interface also receives the transcoded content back from the gateway device upon completion of the transcoding of the received content by the gateway device. Upon receipt of the transcoded content from the gateway device by the communications interface the processor directs the communications interface to forward the transcoded content to a WiFi client associated with the proximate electronic device capable of better rendering quality.

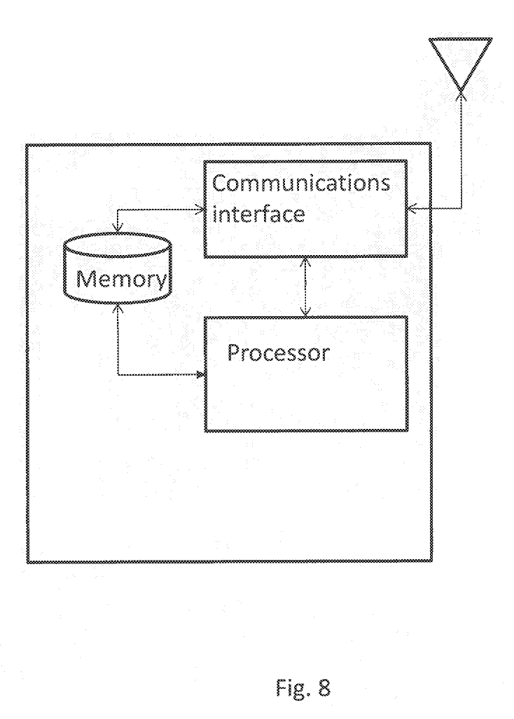

FIG. 8 is a block diagram of an exemplary MoCA client device in accordance with the principles of the proposed method and apparatus. The MoCA client device receives content from a mobile device by the communications interface. The received content may be stored in memory temporarily. The communications interface is directed by the processor to forward the received content to a gateway device for transcoding. The communications device receives the transcoded content back from the gateway device and after decoding the content it is directed by the processor to forward the transcoded content to an electronic device capable of rendering better quality associated with the MoCA client.

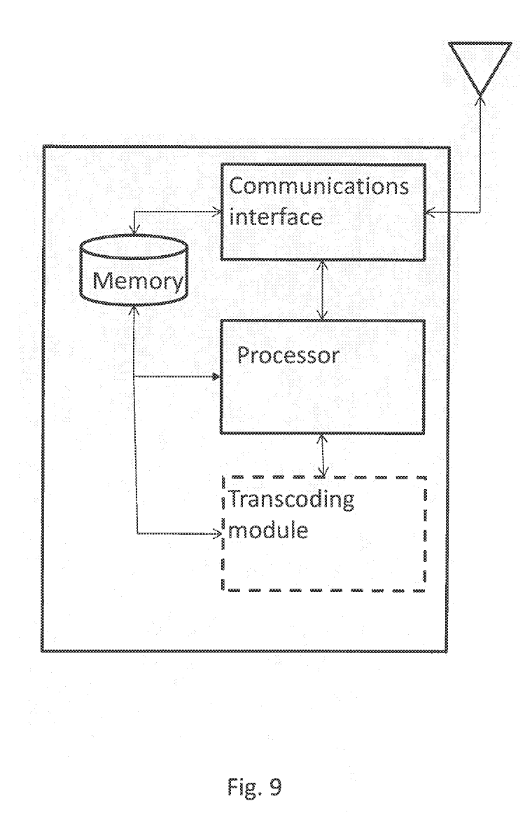

FIG. 9 is a block diagram of an exemplary gateway device in accordance with the principles of the proposed method and apparatus. The communications interface of the gateway device receives content from a MoCA client device or an access point. The gateway device may store the received content in memory. The transcoding module transcodes the received content. The transcoding module is outlined in dashes to indicate that the transcoding module may be part of the processor or a separate module in the gateway device. Upon completion of the transcoding of the received content, the processor directs the communications interface to forward the transcoded content to the device (MoCA client device or access point) from which the gateway device received the content.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the proposed method and apparatus is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

It is to be further understood that, because some of the constituent system components and method steps depicted in the accompanying figures are preferably implemented in software, the actual connections between the system components (or the process steps) may differ depending upon the manner in which the proposed method and apparatus is programmed. Given the teachings herein, one of ordinary skill in the related art will be able to contemplate these and similar implementations or configurations of the proposed method and apparatus.

1-18. (canceled)

19. A method, comprising:
receiving content on a mobile device;
determining if said mobile device is proximate to an electronic device, said electronic device capable of providing a rendering quality different than a rendering quality of said mobile device, wherein a format of said received content is different than a format for rendering said received content on said electronic device; and
forwarding said received content to a network device associated with said electronic device responsive to said determination.

20. The method according to claim 19, wherein said rendering quality includes at least one of audio rendering quality and video rendering quality.

21. The method according to claim 19, wherein said network device is one of an access point and a multimedia over cable alliance device.

22. A method, comprising:
receiving content, by said access point, from a mobile device;
determining if a format of said received content is supported by said access point;
determining quality of said received content; and
determining if said access point has sufficient processing power to transcode said received content.

23. The method according to claim 22, further comprising:
transcoding said received content by said access point responsive to said determining if said access point has sufficient processor power to transcode said received content;
forwarding said transcoded content to a WiFi client.

24. The method according to claim 22, further comprising:
forwarding said received content to a gateway device responsive to said determining if said access point has sufficient processor power to transcode said received content;
receiving transcoded content from said gateway device; and
forwarding said transcoded content to a WiFi client.

25. A method, comprising:
receiving content, by a network device, from a mobile device;
determining if a format of said received content is supported;
determining if said network device has sufficient power to transcode the received content;
transcoding said received content to a different format for rendering, if said network device has sufficient power to perform said transcoding;
forwarding said received content to a gateway device for transcoding if said network device has insufficient power to perform said transcoding;
receiving transcoded content from said gateway device; and
forwarding said transcoded content to an electronic device for rendering, said transcoding having been performed by said network device or by said gateway device.

26. A mobile device, comprising:
a communications interface, said communications interface receiving content on said mobile device;
a processor, said processor determining if said mobile device is proximate to an electronic device, said electronic device capable of providing a rendering quality different than a rendering quality of said mobile device, wherein a format of said received content is different than a format for rendering said received content on said electronic device; and
said communications interface forwarding said received content to network device associated with said electronic device responsive to said determination of said processor.

27. The mobile device according to claim 26, wherein said rendering quality includes at least one of audio rendering quality and video rendering quality.

28. The mobile device according to claim 26, wherein said network device is one of an access point and a multimedia over cable alliance device.

29. An access point, comprising:
a communications interface, said communications interface receiving content, from a mobile device;
a processor configured to:
determine a format of said received content, said communications interface in bi-directional communications with said processor;
determine if a format of said received content is supported by said access point;
determine quality of said received content; and
determine if said access point has sufficient processing power to transcode said received content.

30. The access point according claim 29, further comprising:
said processor transcoding said received content responsive to said determining if said access point has sufficient processor power to transcode said received content, said processor in bi-directional communications with said processor; and
said communications interface forwarding said transcoded content to a WiFi client.

31. The access point according to claim 29, further comprising: said communications interface forwarding said received content to a gateway device responsive to said determining if said access point has sufficient processor power to transcode said received content;
said communications interface receiving transcoded content from said gateway device; and
said communications interface forwarding said transcoded content to a WiFi client.

32. A network device, comprising:
a communications interface, said communications interface receiving content, by said network device, from a mobile device;
said communications interface forwarding said received content to a gateway device;
said communications interface receiving transcoded content from said gateway device; and
said communications interface forwarding said transcoded content to an electronic device for rendering.

33. A mobile device, comprising:
means for receiving content on said mobile device;
means for determining if said mobile device is proximate to an electronic device, said electronic device capable of providing a rendering quality different than a rendering quality of said mobile device, wherein a format of said received content is different than a format for rendering said received content on said electronic device; and
means for forwarding said received content to network device associated with said electronic device responsive to said determination.

34. The mobile device according to claim 32, wherein said rendering quality includes at least one of audio rendering quality and video rendering quality.

35. The mobile device according to claim 32, wherein said network device is one of an access point and a multimedia over cable alliance device.

36. An access point, comprising:
means for receiving content, by said access point, from a mobile device;
means for determining if a format of said received content is supported by said access point;
means for determining quality of said received content; and
means for determining if said access point has sufficient processing power to transcode said received content.

37. The access point according to claim 35, further comprising:
means for transcoding said received content by said access point responsive to said determining if said access point has sufficient processor power to transcode said received content; and
means for forwarding said transcoded content to a WiFi client.

38. The access point according to claim 35, further comprising:
means for forwarding said received content to a gateway device responsive to said determining if said access point has sufficient processor power to transcode said received content;
means for receiving transcoded content from said gateway device; and
means for forwarding said transcoded content to a WiFi client.

39. A network device, comprising:
means for receiving content, by said network device, from a mobile device;
means for determining if a format of said received content is supported;
means for determining if said network device has sufficient power to transcode the received content;
means for transcoding said received content to a different format for rendering, if said network device has sufficient power to perform said transcoding;
means for forwarding said received content to a gateway device for transcoding if said network device has insufficient power to perform said transcoding;
means for receiving transcoded content from said gateway device; and
means for forwarding said transcoded content to an electronic device for rendering, said transcoding having been performed by said network device or by said gateway device.
